(19) United States
(12) Patent Application Publication
(10) Pub. No.: US 2025/0110609 A1
(43) Pub. Date: Apr. 3, 2025

(54) COMPUTER OPERATING SYSTEM AND OPERATING METHOD THEREOF

(71) Applicant: Qisda Corporation, Taoyuan City (TW)

(72) Inventors: Chao-Shun YU, Taoyuan City (TW); Ya-Hui LIAN, Taoyuan City (TW); Wen-Chang CHEN, Taoyuan City (TW); Chun-Sheng HU, Taoyuan City (TW)

(73) Assignee: Qisda Corporation, Taoyuan City (TW)

(21) Appl. No.: 18/882,957

(22) Filed: Sep. 12, 2024

(30) Foreign Application Priority Data
Oct. 2, 2023 (TW) 112137700

(51) Int. Cl. G06F 3/04817; G06F 9/451

(52) U.S. Cl. CPC G06F 3/04817; G06F 9/451

(57) ABSTRACT

A computer operating system is provided. The computer operating system includes a control host, a display device, and a mouse. The display device is connected to the control host. The mouse is connected to the control host. The control host is used to generate a first mouse icon on the display device and generate a second mouse icon on the display device when the first mouse icon exists, wherein a pattern of the first mouse icon is different from a pattern of the second mouse icon.

This application claims the benefit of Taiwan application Serial No. 112137700, filed Oct. 2, 2023, the subject matter of which is incorporated herein by reference.

### BACKGROUND OF THE INVENTION

### Field of the Invention

The invention relates in general to a computer, and more particularly to a computer operating system and an operating method thereof.

### Description of the Related Art

Along with the flourishing development in the display market, the market share of wide screen display device increases significantly and the resolution of high-quality image also increases to meet consumers' requirements. However, since the wide screen display device has a larger width, the user needs to horizontally move the mouse icon for a longer distance when operating with a mouse or locate the mouse icon. As a result, it is not easy to operate with the mouse or it is difficult to locate the mouse icon.

### SUMMARY OF THE INVENTION

The invention is directed to a computer operating system and an operating method thereof used to generate multiple mouse icons on the display device for the convenience of the user's operation.

According to one embodiment of the present invention, a computer operating system is provided. The computer operating system includes a control host, a display device, and a mouse. The display device is connected to the control host. The mouse is connected to the control host. The control host is used to generate a first mouse icon on the display device and generate a second mouse icon on the display device when the first mouse icon exists, wherein a pattern of the first mouse icon is different from that of the second mouse icon.

According to another embodiment of the present invention, a computer operating method is provided. The method includes the following steps. A mouse is connected to a control host. A first mouse icon is generated on a display device by the control host, and a second mouse icon is generated on the display device by the control host when the first mouse icon exists, wherein a pattern of the first mouse icon is different from that of the second mouse icon.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of a computer operating system according to an embodiment of the invention.

FIG. 2 is a schematic diagram of a computer operating system according to another embodiment of the invention.

FIG. 3 is a schematic diagram of a computer operating system according to another embodiment of the invention.

FIG. 4 is a flowchart of a computer operating method according to an embodiment of the invention.

FIG. 5 is a flowchart of a computer operating method according to another embodiment of the invention.

FIG. 6 is a flowchart of a mouse icon switching method according to an embodiment of the invention.

### DETAILED DESCRIPTION OF THE INVENTION

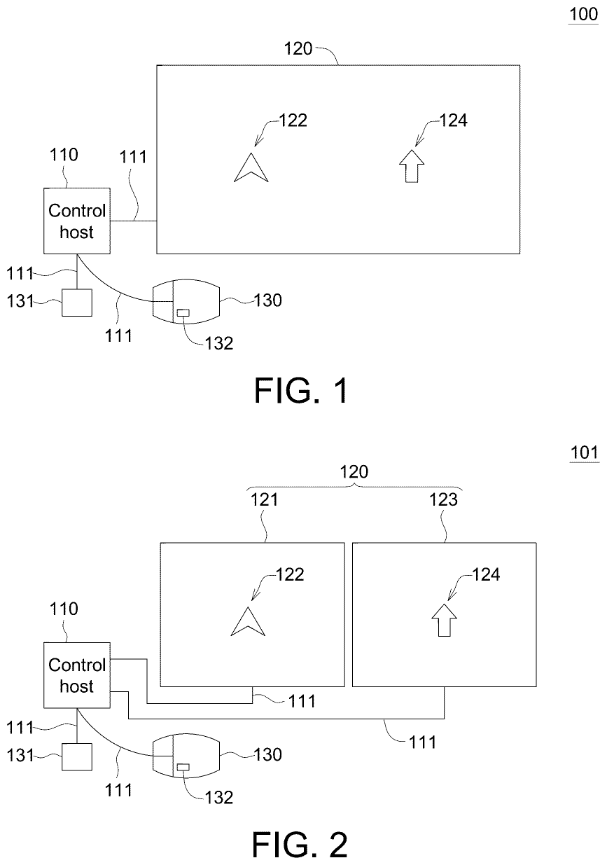

Referring to FIG. 1, a schematic diagram of a computer operating system 100 according to an embodiment of the invention is shown. The computer operating system 100 includes a control host 110, a display device 120 and a mouse 130. The display device 120 is connected to the control host 110. The mouse 130 is connected to the control host 110. The control host 110 is used to generate a first mouse icon 122 on the display device 120 and generate a second mouse icon 124 on the display device 120 when the first mouse icon 122 exists, wherein a pattern of the first mouse icon 122 is different from that of the second mouse icon 124.

In an embodiment, the control host 110 can be a computer connected to the display device 120, the mouse 130 or other computer peripheral device through a signal line 111 or connected to the display device 120, the mouse 130 or other computer peripheral device through a wireless communication device (such as Wi-Fi or Bluetooth). The control host 110 may include a power module, a processor, a control chip, a signal transmission interface, an operating system, and a control interface of a computer peripheral device and/or an application software. The computer peripheral device may include input devices, such as mouse 130, keyboard, touch pad and/or game joystick, and output devices, such as speaker and display device 120.

In an embodiment, the user can input a control signal using the mouse 130, the keyboard, the touch pad, and/or the game joystick. When receiving the control signal, the control host 110 can output a corresponding signal to the speaker and/or the display device 120 in response to the user's operation. As indicated in FIG. 1, when the user moves the mouse 130, the control host 110 generates a first mouse icon 122 on the display device 120. When the user presses a press-key 131 of a keyboard or a press-key 132 of the mouse 130 (not the left key or right key of the mouse), the control host 110 generates a second mouse icon 124 at a position corresponding to the first mouse icon 122 or at a designated position, wherein the pattern of the first mouse icon 122 is different from that of the second mouse icon 124. The pattern can have any shapes, colors, or a combination thereof, such as [symbol] , [symbol] , [symbol] , [symbol] , [symbol] , and the invention does not have specific restrictions in this regard.

Besides, the invention is not limited to switching between two mouse icons; rather, the invention allows switching among multiple mouse icons. The pattern of each mouse icon is different; each mouse icon can be switched by pressing the same press-key 131 or 132 several times or by pressing the press-keys 131 and 132 at different positions.

In an embodiment, the display device 120 can be a display with a screen size of 4:3, a wide screen size of 16:9, a ultra-wide screen size of 21:9, a ultra-wide screen size of 32:9, or a ultra-wide screen sized display composed of two or more than two displays of any of the above screen sizes, and the invention does not have specific restrictions in this regard.

Referring to FIG. 2, a schematic diagram of a computer operating system 101 according to another embodiment of the invention is shown. As indicated in FIG. 2, the computer operating system 101 includes a control host 110, a first display device 121, a second display device 123 and a mouse 130. The first display device 121 and the second display device 123 are respectively connected to the control host 110. The control host 110 is used to generate a first mouse icon 122 on the first display device 121 and generate a second mouse icon 124 on second display device 123. The first mouse icon 122 and the second mouse icon 124 co-exist, and the pattern of the first mouse icon 122 is different from that of the second mouse icon 124.

As indicated in FIG. 2, the first display device 121 and second display device 123 form a display device 120 with a wide screen size. When the user moves the mouse 130, the control host 110 generates a first mouse icon 122 on the first display device 121, so that the user can conveniently operate the first mouse icon 122 on the first display device 121. When the user presses a press-key 131 of the keyboard or a press-key 132 of the mouse 130 (not the left key or right key of the mouse), the control host 110 correspondingly generates a second mouse icon 124 on the second display device 123, so that the user can conveniently operate the second mouse icon 124 on the second display device 123. Thus, the user can switch between the first mouse icon 122 and the second mouse icon 124 by pressing/releasing the same press-key 131 or 132 or by pressing and releasing a press-key 131 and triggering another press-key 132 (or another press-key of the keyboard).

In the invention, the display device is not limited to the first display device 121 and the second display device 123, and the number of display devices can be more than two. Each display device can correspondingly display at least one mouse icon, and the pattern of each mouse icon is different. Each mouse icon can be switched by pressing the same press-key 131 or 132 several times or by pressing the press-keys 131 and 132 at different positions.

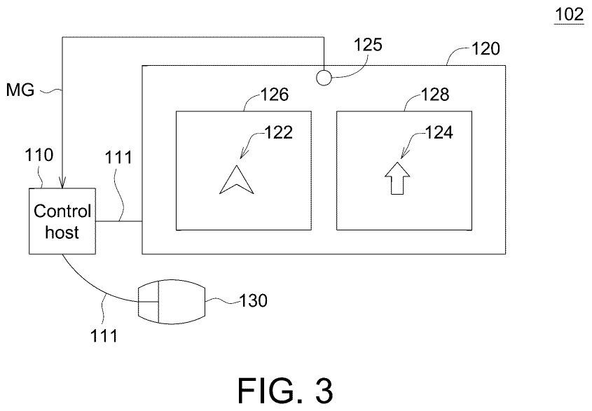

Referring to FIG. 3, a schematic diagram of a computer operating system 102 according to another embodiment of the invention is shown. As indicated in FIG. 3, the computer operating system 102 includes a control host 110, a display device 120, a camera 125 and a mouse 130. The control host 110 is used to generate a first mouse icon 122 on the display device 120 and generate a second mouse icon 124 on the display device 120 when the first mouse icon 122 exists. Besides, the camera 125 is used to capture a user image information MG, wherein the control host 110 determines the position of the second mouse icon 124 according to the user image information MG.

In an embodiment, the camera 125, which can be an image sensor arranged on the display device 120, is used to capture the image of the user at the front of the display device 120 then transmit the image to the control host 110. After receiving the user image information MG, the control host 110 performs image recognition to calculate the position of human eyes and the position of line of sight on the screen, and determine the screen region and position attended by human eyes among the user image information MG, so that the control host 110 can generate the second mouse icon 124 at a designated position on the display device 120 according to the user image information MG.

That is, as indicated in FIG. 3, when the camera 125 detects that the position of the sigh of human eyes corresponds the first screen region on the display device 120, the control host 110 controls the position of the first mouse icon 122 in the first screen region; when the camera 125 detects that the position of the sigh of human eyes corresponds the second screen region on the display device 120, the control host 110 can generate the second mouse icon 124 in the second screen region and control the position of the second mouse icon 124. The first screen region is such as the first working window 126 of FIG. 3 or the first display device 121 of FIG. 2. The second screen region is such as the second working window 128 of FIG. 3 or the second display device 123 of FIG. 2. The control host 110 can generate the first mouse icon 122 and the second mouse icon 124 respectively on at least two display devices 120 or within at least two working windows 126 and 128. Instead of switching between the first mouse icon 122 and the second mouse icon 124 using the press-keys 131/132, in the present embodiment, the first mouse icon 122 and the second mouse icon 124 are switched according to the user image information MG, so that the user can conveniently operate the mouse 130.

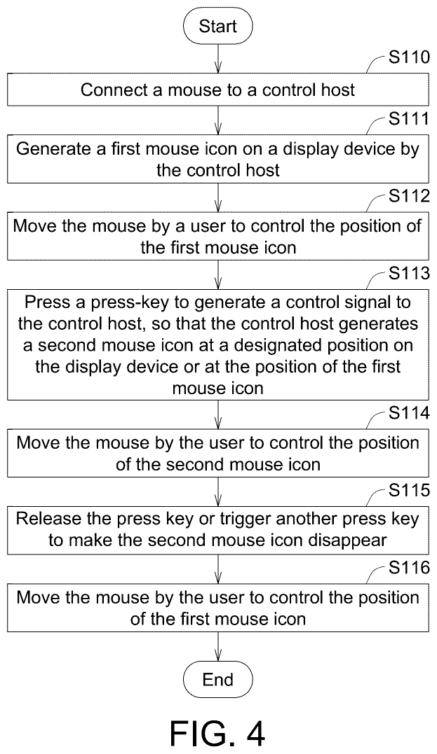

Details of the computer operating method are exemplified in a number of embodiments below. Referring to FIG. 1 and FIG. 4, FIG. 4 is a flowchart of a computer operating method according to an embodiment of the invention. The computer operating method includes the following steps S110-S116. Firstly, the method begins at step S110, a mouse 130 is connected to a control host 110. In step S111, a first mouse icon 122 is generated on a display device 120 by the control host 110. In step S112, the mouse 130 is moved by the user to control the position of the first mouse icon 122. In step S113, a press-key 131 and/or 132 is pressed to generate a control signal to the control host 110, so that the control host 110 generates a second mouse icon 124 at a designated position on the display device 120 or at the position of the first mouse icon 122.

In step S113 disclosed above, the press-key that is pressed can be a key combination formed of a press-key 131 (such as the Ctrl key) on the keyboard and any numeric key or a press-key 132 of the mouse 130 (not the left key and right key of the mouse), and the function correspondingly triggered by the press-key 131 or 132 can be pre-set in the control host 110. The numeric key can represent the numbering of a mouse icon. For instance, the “1” key represents the first mouse icon 122, the “2” key represents the second mouse icon 124, and the rest can be obtained by the same analogy. When the user presses the press-key 131 or 132, the first mouse icon 122 will stay without moving (cannot be operated), the second mouse icon 124 can be generated on the display device 120 according to the user's pre-setting. In step S114, the mouse 130 is moved by the user to control the position of the second mouse icon 124. In step S115, when the user would like to switch the first mouse icon 122 or other mouse icon, the original press-key 131 is released or another press-key 132 is triggered, so that the second mouse icon 124 will disappear. Examples of triggering another press-key include triggering both of the Ctrl key and the Esc key to return to the operation of the first mouse icon 122 or triggering the Ctrl key and any one of numeric keys to switch to other mouse icon. In the invention, switching is not limited to be between two mouse icons; rather, the invention allows the switching among more than two mouse icons. In step S116, the mouse 130 is moved by the user to control the position of the first mouse icon 122.

In an embodiment, the above steps S113 to S116 are repeated. The user can switch between the first mouse icon 122 and the second mouse icon 124 by pressing/releasing the same press-key 131 or 132 or by pressing and releasing a press-key 131 and triggering another press-key 132. Since the user does not need to horizontally move the mouse icon for a longer distance or locate the mouse icon, the problems of the mouse 130 being not easy to operate or the mouse icon being difficult to locate can be avoided.

The computer operating method disclosed above can also be used in the computer operating system 101 of FIG. 2 or the computer operating system 102 of FIG. 3, so that the control host 110 can generate the first mouse icon 122 and the second mouse icon 124 respectively on at least two display devices 120 or within at least two working windows 126 and 128, and the details are not repeated here.

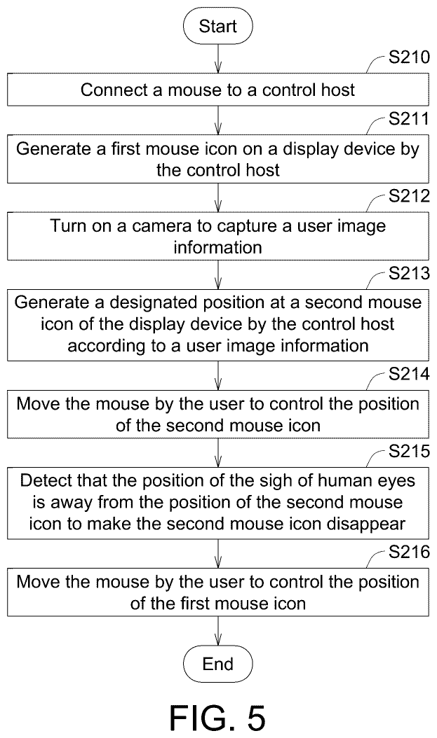

Referring to FIG. 3 and FIG. 5, FIG. 5 is a flowchart of a computer operating method according to another embodiment of the invention. The computer operating method includes the following steps S210-S216. Firstly, the method begins at step S210, a mouse 130 is connected to a control host 110. In step S211, a first mouse icon 122 is generated on a display device 120 by a control host 110. In step S212, a camera 125 is turned on to capture a user image information MG. In step S213, a designated position is generated at a second mouse icon 124 of the display device 120 by the control host 110 according to a user image information MG.

In step S213 disclosed above, the user image information MG may include information such as the rotation angle of the head, the position of human eyes, the position of the iris and/or the position of line of sight on the screen. For instance, when the camera 125 detects that the position of the sigh of human eyes corresponds to a first screen region on the display device 120, the control host 110 controls the position of the first mouse icon 122 in the first screen region; when the camera 125 detects that the position of the sigh of human eyes corresponds to a second screen region on the display device 120, the control host 110 can generate a second mouse icon 124 in the second screen region and control the position of the second mouse icon 124.

In step S214, the mouse 130 is moved by the user to control the position of the second mouse icon 124. In step S215, when the user would like to switch to the first mouse icon 122, the user only needs to rotate his/her head; once the control host 110 detects that the position of the sigh of human eyes is away from the position of the second mouse icon 124, the second mouse icon 124 will disappear. In step S216, the mouse 130 is moved by the user to control the position of the first mouse icon 122.

In an embodiment, by repeating the above steps S213 to S216, the user can switch between the first mouse icon 122 and the second mouse icon 124 according to the user image information MG. Since the user does not need to horizontally move the mouse icon for a longer distance or locate the mouse icon, the problems of the mouse 130 being not easy to operate or the mouse icon being difficult to locate can be avoided.

The computer operating method disclosed above can also be used in the computer operating system 101 of FIG. 2 or the computer operating system 102 of FIG. 3, so that the control host 110 can generate the first mouse icon 122 and the second mouse icon 124 respectively on at least two display devices 120 or within at least two working windows 126 and 128, and the details are not repeated here.

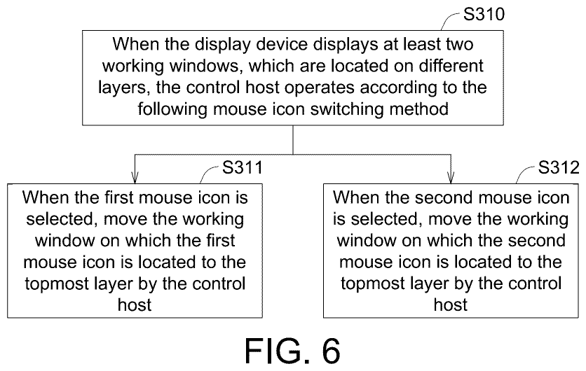

Referring to FIG. 6, a flowchart of a mouse icon switching method according to an embodiment of the invention is shown. In the present embodiment, the switching of mouse icon can indicate the position of the target mouse icon that the user would like to control by way of connecting and extending a line, moving an arrow, or dragging the current mouse icon to be merged with the target mouse icon. Besides, in step S310, when the display device 120 displays at least two working windows 126 and 128, which are located on different layers (such as an upper layer and a lower layer overlapped under the upper layer), the control host 110 can operate according to the following mouse icon switching method. In step S311, when the first mouse icon 122 is selected, the working window on which the first mouse icon 122 is located is moved to the topmost layer by the control host 110. In step S312, when the second mouse icon 124 is selected, the working window on which the second mouse icon 124 is located is moved to the topmost layer by the control host 110. By the same analogy, if there are more mouse icons to be switched, the switching method is disclosed above.

That is, the working window on which the mouse icon is located and the application thereof can be turned on and operated together, so that the working window on which the mouse icon is located currently under control remains on the topmost layer, and the working window on which the mouse icon is located not currently under control is moved to the next layer to avoid shielding the mouse icon and working window currently under control.

While the invention has been described by way of example and in terms of the preferred embodiment(s), it is to be understood that the invention is not limited thereto. Based on the technical feature points embodiments of the present invention, a person ordinarily skilled in the art will be able to make various modifications and similar arrangements and procedures without breaching the spirit and scope of protection of the invention. Therefore, the scope of protection of the present invention should be accorded with what is defined in the appended claims.

What is claimed is:

1. A computer operating system, comprising:
a control host;
a display device connected to the control host; and
a mouse connected to the control host, which is used to generate a first mouse icon on the display device and generate a second mouse icon on the display device when the first mouse icon exists, wherein a pattern of the first mouse icon is different from a pattern of the second mouse icon.

2. The computer operating system according to claim 1, further comprising a press-key used to generate a control signal to the control host, wherein the control host generates the second mouse icon when the press-key is pressed, so that the second mouse icon disappears when the press-key is released or another press-key is triggered.

3. The computer operating system according to claim 1, wherein the control host generates the second mouse icon at a position of the first mouse icon.

4. The computer operating system according to claim 1, wherein the control host generates the second mouse icon at a designated position of the display device.

5. The computer operating system according to claim 1, further comprising a camera used to capture a user image information, wherein the control host generates the second mouse icon at a designated position of the display device according to the user image information.

6. The computer operating system according to claim 1, wherein the display device is used to display at least two working windows, the control host generates the first mouse icon and the second mouse icon respectively within the at least two windows.

7. The computer operating system according to claim 6, wherein the control host moves one of the at least one working windows on which the first mouse icon or the second mouse icon is located to a topmost layer.

8. The computer operating system according to claim 1, wherein the display device comprises a first display device and a second display device respectively connected to the control host; the control host generates the first mouse icon on the first display device and generates the second mouse icon on the second display device.

9. The computer operating system according to claim 8, wherein the first display device is used to display a first working window, the second display device is used to display a second working window, and the control host generates the first mouse icon and the second mouse icon respectively within the first and second windows.

10. The computer operating system according to claim 9, further comprising a camera used to capture a user image information, wherein the control host generates the first mouse icon at a designated position of the first display device and the second mouse icon at a designated position of the second display device respectively according to the user image information.

11. A computer operating method, comprising:
connecting a mouse to a control host; and
generating a first mouse icon on a display device by the control host and generating a second mouse icon on the display device by the control host when the first mouse icon exists, wherein a pattern of the first mouse icon is different from a pattern of the second mouse icon.

12. The computer operating method according to claim 11, further comprising pressing a press-key to generate a control signal to the control host, wherein the control host generates the second mouse icon when the press-key is pressed, so that the second mouse icon disappears when the press-key is released or another press-key is triggered.

13. The computer operating method according to claim 11, wherein the control host generates the second mouse icon at a position of the first mouse icon.

14. The computer operating method according to claim 11, wherein the control host generates the second mouse icon at a designated position of the display device.

15. The computer operating method according to claim 11, further comprising activating a camera to capture a user image information, wherein the control host generates the second mouse icon at a designated position of the display device according to the user image information.

16. The computer operating method according to claim 11, wherein when the display device displays at least two working windows, the computer operating method comprises generating the first mouse icon and the second mouse icon respectively within the at least two working windows by the control host.

17. The computer operating method according to claim 16, further comprising moving one of the at least two working windows on which the first mouse icon or the second mouse icon is located to a topmost layer by the control host.

18. The computer operating method according to claim 11, wherein the display device comprises a first display device and a second display device respectively connected to the control host; the control host generates the first mouse icon on the first display device and generates the second mouse icon on the second display device.

19. The computer operating method according to claim 18, wherein the first display device is used to display a first working window, the second display device is used to display a second working window, and the control host generates the first mouse icon and the second mouse icon respectively within the first and second windows.

20. The computer operating method according to claim 19, further comprising activating a camera to capture a user image information, wherein the control host generates the first mouse icon at a designated position of the first display device and the second mouse icon at a designated position of the second display device respectively according to the user image information.
